(19) United States
(12) Patent Application Publication
(10) Pub. No.: US 2010/0268932 A1
(43) Pub. Date: Oct. 21, 2010

(54) SYSTEM AND METHOD OF VERIFYING THE ORIGIN OF A CLIENT REQUEST

(76) Inventor: Deb Priya Bhattacharjee, Fremont, CA (US)

Correspondence Address: Deb Priya Bhattacharjee, 40625 Ladero St., Fremont, CA, 94539, US

(21) Appl. No.: 12/424,875

(22) Filed: Apr. 16, 2009

(51) Int. Cl. H04L 29/06; H04L 9/32

(52) U.S. Cl. 713/151; 713/168; 713/156

(57) ABSTRACT

A system and method for verifying the origin of a client request. The system includes two devices, a “Security Device” which resides within the web-server in the client end, and an “Authenticator Device” which resides within the web-server in the server end. The “Security Device” adds an Extended Validation SSL (EV SSL) certificate to the client-side web-request. The “Authenticator Device” then parses the http request from the client, gets the EV SSL certificate and gets the “Organization Name” of the client from this EV SSL certificate. If the “Organization Name” matches a list of “Organization” that the “Authenticator Device” is allowed to do a transaction, then the client request is authenticated and the transaction goes through, else the client-request is denied.

### FIELD OF THE INVENTION

This invention pertains to a system and method of communication between a web-browser client and a web-server. In particular, this invention deals with authenticating the web-browser client to be from a valid and authenticated “Organization”.

### BACKGROUND OF THE INVENTION

Today any secured transaction over the Internet uses Secured Socket Layer (SSL) protocol to establish connection between the client and the server. The SSL protocol uses the Public Key Infrastructure (PKI) technology for authentication. In the PKI technology, an official certification authority (CA) provides the security Certificate that is used for authentication of a server. There are enhancements made to this viz. Extended Validation SSL (EVSSL) for extra validation of the organization where the server is situated. A certifying authority e.g. Verisign does extra level of validation of the organization registration, organization address, domain ownership, Business status etc. before issuing an EVSSL certificate to the organization that owns the server. So by examining the EV SSL certificate a client browser can be reasonably sure about the organization of the server where the Internet response or request is coming from. Just like a server needs to be authenticated, in a similar fashion many servers would like to be sure about the client's security credentials like Organization, domain ownership etc. as well. Before the Internet age, there were severe restrictions on clients connected to a secured server like a corporate server. The security of the clients was established by either limiting the physical connection between client and server, or having some kind of access-control mechanism. In this day and age of Internet and ubiquitous social networking application, there is a need for validating the organization from where a client request is coming to a server. And it is impossible to restrict the client request by any physical means.

A social networking site catering towards middle school should validate whether a client requesting for account creation is actually originating from a middle school or not. A simple solution for a server to be sure about the client's authenticity is for the client to also send across an EV SSL certificate to the server. The server can then verify the credentials very easily and validate the authenticity of the client.

### BRIEF DESCRIPTIONS OF DRAWINGS

FIG. 1 is a block diagram showing the various devices involved in this system.

FIG. 2 is a flowchart that describes the method of authenticating a client request to be originating from a trusted organization.

### DETAIL DESCRIPTION OF INVENTION

It should be appreciated that the present invention can be implement in numerous ways, including as a process, an apparatus, a system, or a computer readable medium such as computer readable storage medium or computer network wherein program instructions are send over optical or electronic communication links. It should be noted that the order of the steps of disclosed processes may be altered within the scope of the invention.

A detailed description of one or more preferred embodiments of the invention are provided below that shows by a way of example the principles of the invention. While the invention is described in connection with such embodiments, it should be understood that the invention is not limited to any embodiment. For the purpose of examples, numerous specific details are set forth in the following description in order to provide a thorough understanding of the present invention. E.g. in an embodiment below talks specifically about using EV SSL certificate but any other valid credential can be used. For the purpose of clarity, technical material that is known in the fields related to the invention has not been described in details so that the present invention is not unnecessarily obscured.

Also techniques, systems, subsystems, and methods described and illustrated in the various embodiments as discrete or separate may be combined or integrated with other systems, subsystems, modules, techniques, or methods without departing from the scope of the present disclosure.

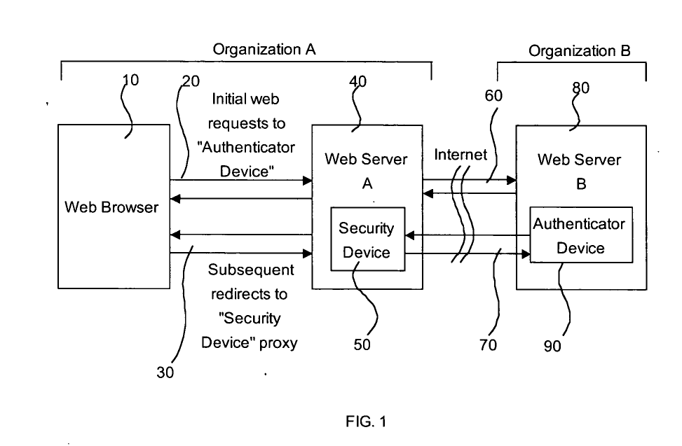

FIG. 1 is a block diagram showing the various devices involved in this system. In an embodiment, a client Web Browser 10 from within the network domain of Organization A issues a web request to the “Authenticator Device” 90 residing within the network domain of Organization B. The “Authenticator Device” 90 is an application within the Web-Server B 80. “Authenticator Device” 90 sends a response back to the client Web Browser 10 asking it to communicate using the “Security Device” 50 as a proxy. From this point onwards Web Browser 10 communicates with “Authenticator Device” 90 only via the “Security Device” 50. The “Security Device” acts as a proxy. Also the “Security Device” 50 should be a SSL enabled device with an EV SSL certificate for enhanced authentication. The “Security Device” 50 is a device which needs to be plugged into Web Server A 40 of Organization A by the website Administrator of Organization A. The “Security Device” 50 adds the EV SSL certificate credentials to the http request which originates from the client Web Browser 10. The Client Web Browser 10 and the “Security Device” 50 resides within the network domain of Organization A. The communication between Organization A and Organization B happens over the Internet 60.

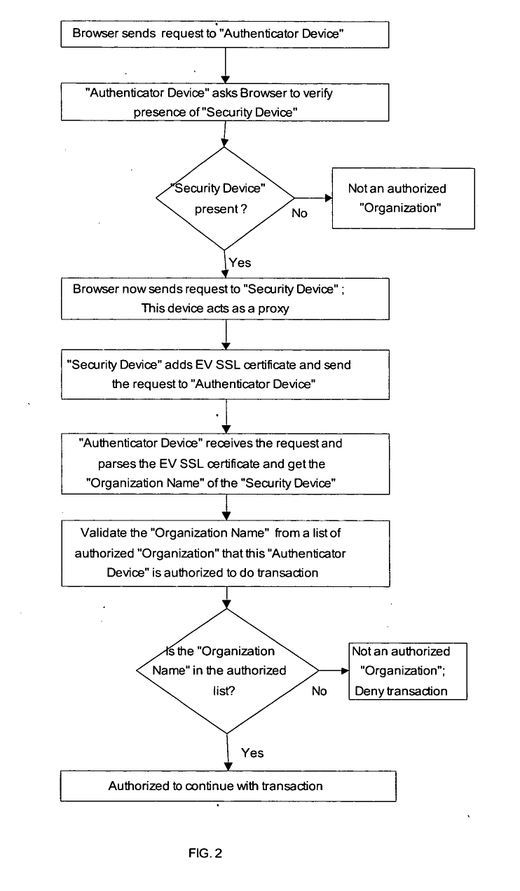

FIG. 2 is a flowchart that describes in detail the method of authenticating a client request to be originating from a trusted organization. In this embodiment, the Web Browser as described in FIG. 10, sends a request to “Authenticator Device” FIG. 1 90. The “Authenticator Device” sends a response back to the Web Browser FIG. 1 10. The response asks the client to start communicating with “Authenticator Device” through the “Security Device” FIG. 1 50 as a proxy. At this point, the method assumes that the “Security Device” FIG. 1 50 is already installed and setup in a standard location by the web administrator of the Web Server A FIG. 1 10. If “Security Device” is not present then the “Organization” is not setup to complete the transaction and hence is not an authorized organization to do a transaction with Organization B. If the “Security Device” FIG. 1 50 is setup, then this device acts as a proxy and all communication between the client Web Browser and the “Authenticator Device” FIG. 1 90 goes through this proxy device. This “Security Device” FIG. 1 50 is SSL enabled and should have a valid EV SSL certificate from a valid Certificate Authority e.g. Verisign. The “Security Device” adds the EV SSL certificate into the web requests going to the “Authenticator Device” FIG. 1 90. The “Authenticator Device” FIG. 1 90 now receives this request and extracts the credentials of the EV SSL certificate. The important information that are needed for authentication purpose are the domain ownership and organizational identity. The “Authenticator Device” of FIG. 1 90 now validates the “Organization Name” from this EV SSL against a pre-authorized list of “Organization” that “Authenticator Device” is allowed to do any kind of transaction. If the “Organization Name” from the EV SSL generated by the “Security Device” in FIG. 1 50 is authenticated, then rest of the transaction is continued, else the transaction is not authorized.

What is claimed is:

1. A system for verifying that the origin of a client request is from a pre-authorized organization over a computer network comprising:
a. A client browser which initiates the request; The client resides within the network domain of an Organization A;
b. The Organization A will have a web-server which has the capability of communicating over SSL;
c. Another web-server residing with the network domain of Organization B and configured to receive requests from the client in Organization A;
d. This web-server is also configured to communicate over SSL and validate the credentials of EV SSL certificates.

2. The web-server in claim 1 b further comprising a “Security Device”.
This “Security Device” is setup to communicate over SSL and will have a valid EV SSL certificate from a valid certification authority.

3. The system of claim 2—the “Security Device”—acts as a proxy through which the client from Organization A communicates with server in Organization B.

4. The system of claim 2—the “Security Device”—adds the EV SSL certificate to the http header of the client's request before sending the request to the server residing on Organization B.

5. The system of claim 1 c further comprising an “Authenticator Device”.

6. The system of claim 5—the “Authenticator Device”—has the capability extracting the credentials from a valid EV SSL certificate.

7. The system of claim 5 further comprising of a list of valid organizations with which it is allowed to do transactions with.

8. A method for the client to send a request from Organization A to Organization B, and Organization B capable of validating that request, the method comprising:
a. A client request from Organization A to start a transaction with the “Authenticator Device” in Organization B;
b. The “Authenticator Device” asks client to start using a “Security Device” already setup in Organization A for further communication;
c. The “Security Device” in Organization A is configured to be SSL enabled and has a valid EV SSL certificate from a valid certificate authority;
d. The “Security Device” now acts as a proxy for all client request to the server in Organization B;
e. The “Security Device” adds the EV SSL credential to all the http request being sent to the “Authenticator Device”;
f. Once the “Security Device” of Organization A sends a request to “Authenticator Device” in Organization B, the “Authenticator Device” can extract the credentials from the EV SSL certificate from the request;
g. The “Authenticator Device” has a pre-defined list of valid Organizations that it is allowed to do transaction with;
h. If the credentials of the EV SSL certificate is part of this pre-defined list, then “Authenticator Device” validates the transaction, else it denies further transactions;
